(19) United States
(12) Patent Application Publication
(10) Pub. No.: US 2019/0230849 A1
(43) Pub. Date: Aug. 1, 2019

(54) Sand Trap Rake For Use On Golf Courses

(71) Applicant: John E. Heitfield, Greenville, OH (US)

(72) Inventor: John E. Heitfield, Greenville, OH (US)

(21) Appl. No.: 15/886,217

(22) Filed: Feb. 1, 2018

(51) Int. Cl. A01D 7/06; A63B 57/50

(52) U.S. Cl. CPC A01D 7/06; A63B 57/50

(57) ABSTRACT

A sand trap rake includes an elongate rake head having a first, front end and a second, back end. The rake head defines a raking direction aligned with a direction extending from the first end to the second end. A plurality of tines are spaced apart along a longitudinal direction of the rake head, transverse to the raking direction. The rake further includes a first elongate smoothing member disposed forwardly from the first end of the rake head, and a second elongate smoothing member disposed rearwardly from the second end. Longitudinal extents of the first and second smoothing members are generally aligned with the longitudinal direction of the rake head. The rake may be used to repair a sand surface by pushing or pulling the rake head along the surface so that sand is directed through the tines and over at least one of the first or second smoothing members.

### TECHNICAL FIELD

The present invention relates generally to tools for treating a sandy soil surface and, more particularly, to a rake for use in sand traps, or bunkers, on golf courses.

### BACKGROUND

Sand traps, or bunkers, are a common form of hazard or obstacle on golf courses and are used to make the game more challenging by increasing the difficulty of play. Golf etiquette mandates that players repair the surface of a sand trap after having landed in and removing a ball from the sand trap, either by attempting to hit out of the sand trap or by taking a stroke penalty. Conventional rakes that have been used to repair the surface of sand traps do not adequately and efficiently restore a smooth surface to the sand which should be left free from furrows, ridges, or other formations in the sand. For example, the use of conventional garden-type rakes is generally unsatisfactory because such rakes leave furrows where the tines have been pulled or pushed through the sand. Moreover, such conventional garden-type rakes are susceptible to causing the accumulation of piled sand at the ends of a push or pull stroke. Various solutions have been proposed to address these problems, but the proposed rakes have generally required a user to turn the rake over and engage the sand surface with an alternative structure. Accordingly, these proposed rakes require additional steps and several passes over the same surface in an attempt to obtain a smooth surface. A need therefore exists for an improved sand trap rake that overcomes these and other drawbacks of tools heretofore proposed to treat the surface of a sand trap or bunker.

### SUMMARY OF THE INVENTION

The present invention provides a sand trap rake that facilitates efficient repair of a sand surface to obtain a smooth surface that is free from furrows, ridges, and piles. In one aspect, the rake may be used in both pushing and pulling motions to repair the sand surface, and does not require users to turn the rake head over. While the invention will be described in connection with certain embodiments, it will be understood that the invention is not limited to these embodiments. On the contrary, the invention includes all alternatives, modifications and equivalents as may be included within the spirit and scope of the present invention.

According to one aspect of the present invention, a sand trap rake for use on golf courses includes an elongate rake head having a first, front end and a second, back end. The rake head defines a raking direction aligned with a direction extending from the first end to the second end. A plurality of tines are spaced apart along a longitudinal direction of the rake head, transverse to the raking direction. The rake further includes a first elongate smoothing member disposed forwardly from the first end of the rake head, and a second elongate smoothing member disposed rearwardly from the second end of the rake head. The first and second smoothing members having longitudinal extents that are generally aligned with the longitudinal direction of the rake head. The lengths of the first and second members may extend beyond the lateral sides of the rake head.

In another aspect, a method of repairing a golf sand trap subsequent to play includes engaging the sand surface of the trap with a sand trap rake having a rake head with a plurality of tines and first and second smoothing members as shown and described herein, and then pushing or pulling the rake head along the sand surface in the raking direction so that sand is directed through the tines and over at least one of the first or second smoothing members.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the present invention.

FIG. 1 is a partial front perspective view of an exemplary sand trap rake in accordance with the principles of the present disclosure.

FIG. 2 is a rear perspective view of the rake of FIG. 1.

FIG. 2A is a cross-sectional view of the rake of FIG. 2, taken along line 2A-2A.

FIG. 3 is a front elevation view of the rake of FIG. 1.

FIG. 4 is a rear elevation view of the rake of FIG. 1.

FIG. 5 is a left-side elevation view of the rake of FIG. 1.

FIG. 6 is a right-side elevation view of the rake of FIG. 1.

FIG. 7 is a top plan view of the rake of FIG. 1.

FIG. 8 is bottom view of the rake of FIG. 1.

FIGS. 9A-9D illustrate use of the rake of FIG. 1, wherein the rake head is drawn toward a user.

FIGS. 10A-10D illustrate use of the rake of FIG. 1, wherein the rake head is pushed away from a user.

### DETAILED DESCRIPTION

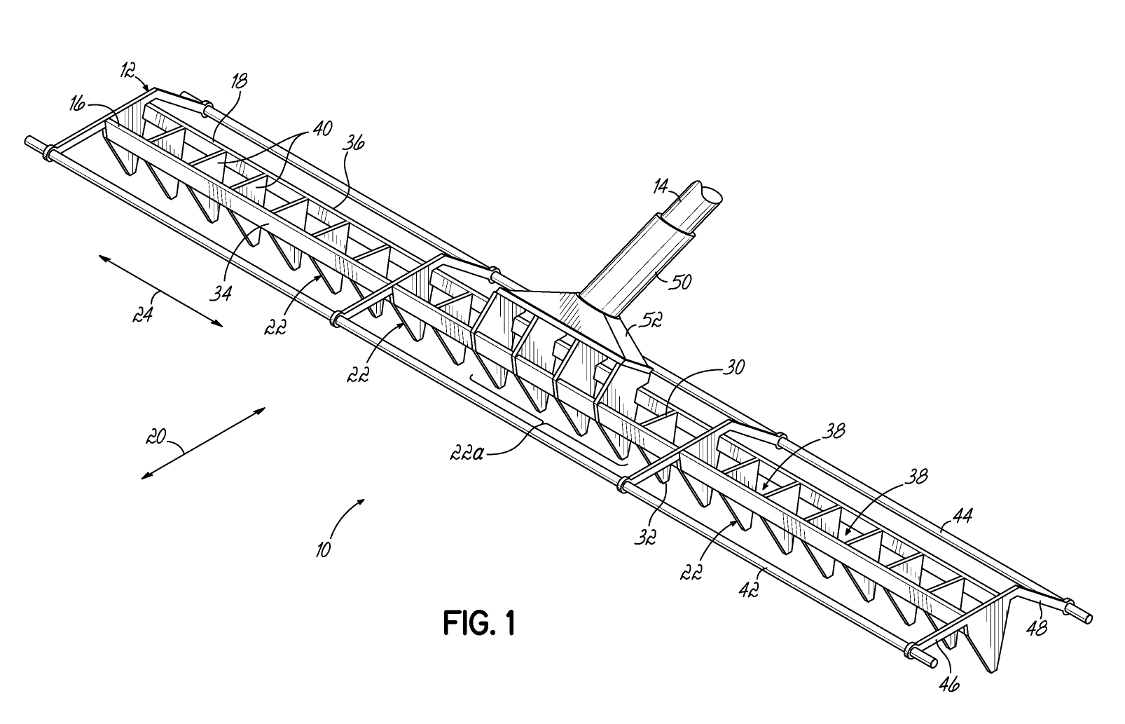

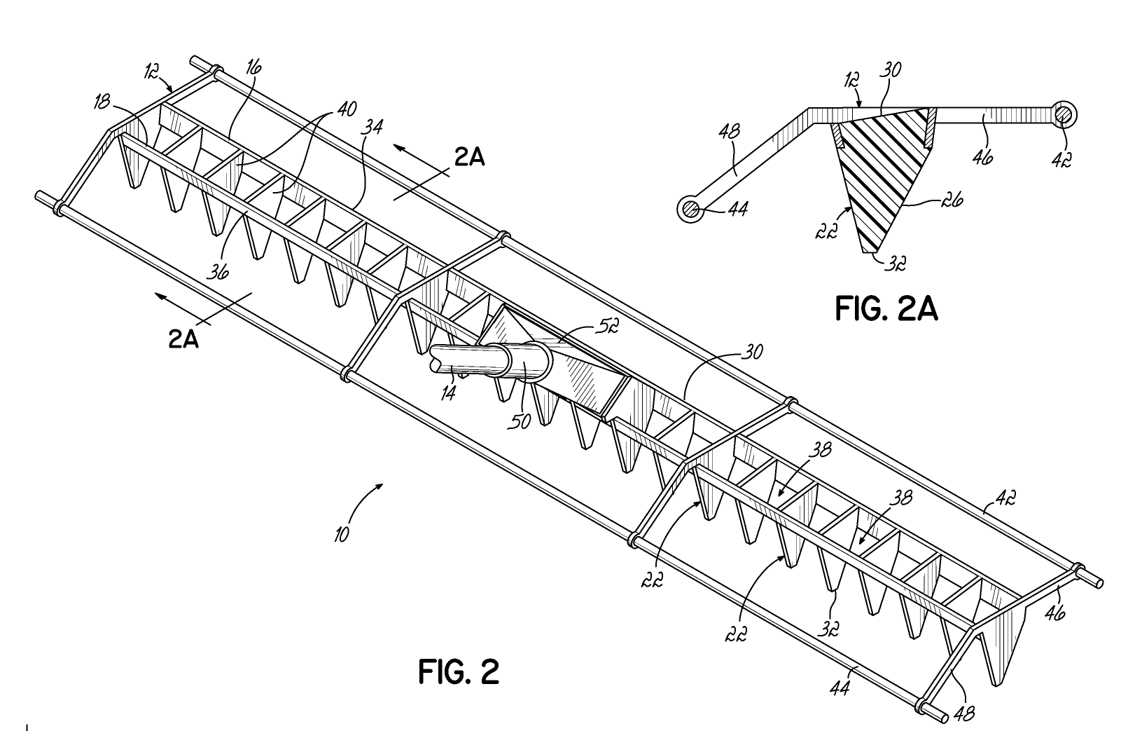

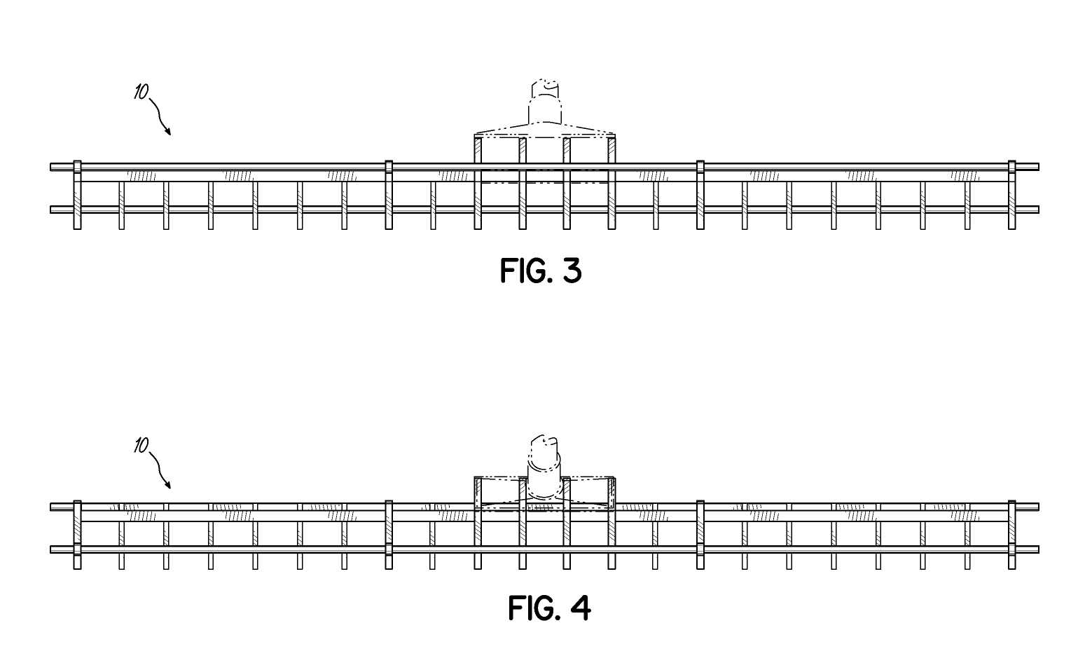

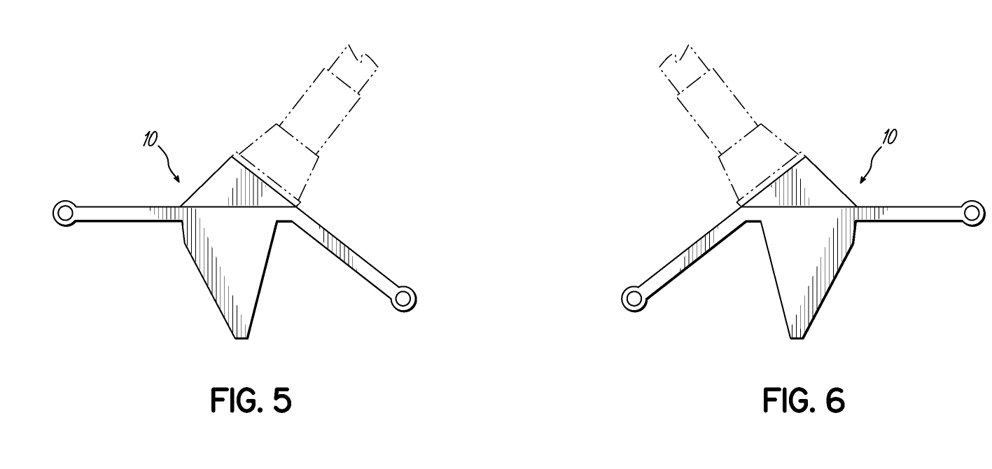

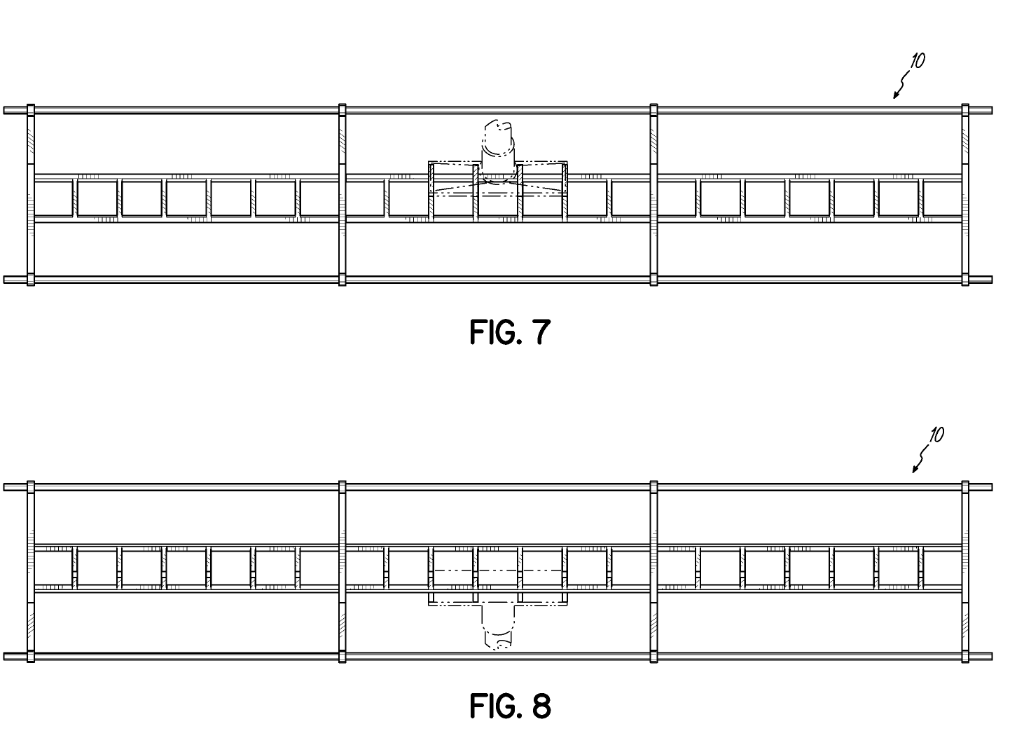

FIGS. 1-8 depict an exemplary embodiment of a sand trap rake 10 in accordance with the principles of the present disclosure. With particular reference to FIGS. 1 and 2, the sand trap rake 10 includes a generally elongate rake head 12 to which a handle 14 may be attached to facilitate using the rake 10 to treat the sand surface of a golf sand trap, or bunker, after removing a ball which has landed in the sand trap, or to treat the surface in the event of any other type of disturbance to the sand trap. In the embodiment shown, the elongate rake head 12 has a first, front end 16 and a second, back end 18 wherein the rake head 12 is configured to be pushed and pulled in a raking direction 20 that is aligned with a direction extending from the first end of the rake head 12 to the second end. A plurality of tines 22 are provided on the rake head 12 and are spaced apart along the longitudinal direction 24 of the rake head 12, which is generally traverse to the raking direction 20. In the embodiment shown, each of the tines 22 comprises a generally planar tine body 26, and the tines 22 are arranged such that the planes of the tines 22 are aligned with the raking direction 20.

With continued reference to FIGS. 1 and 2, and referring further to FIGS. 2A, 5, and 6, the planar bodies 26 of the tines 22 in this embodiment have a generally tapered shape that is longer in the raking direction 20 at a proximal end 30 of the tines 22, near the rake head 12, and gradually becomes narrower at a distal end 32 of the tines 22, spaced from the rake head 12 and extending outwardly therefrom. In one embodiment, the thickness of the planar bodies 26 of at least some of the tines 22 is approximately 5/32 of an inch (3.97 mm). The thickness of the tines 22, as well as the tapered shape, facilitates pulling the rake head 12 through a sand surface to repair any depressions, piles, or other disturbances of the sand surface, while minimizing the creation of furrows after the tines 22 have passed through the sand.

The rake head 12 further includes a first elongate frame member 34 coupled with the tines 22 at the first end 16 of the rake head 12, and a second elongate frame member 36 spaced apart from the first frame member 34 and coupled with the tines 22 at the second end 18 of the rake head 12. The first and second frame members 34, 36 thereby support a plurality of spaced apart tines 22 and provide structural rigidity to the rake head 12. As best seen in FIGS. 1, 2, 7, and 8, the plurality of spaced apart tines 22 define passages 38 that extend between the respective tines 22, and the rake head 12 includes a plurality of openings 40, each of which is aligned with one of the passages 38 and bounded by the first and second frame members 34, 36. This open structure of the rake head 12 allows sand to flow through the passages 38 between the tines 22, and then through the plurality of openings 40 when the rake head 12 is caused to pass through a pile of sand.

The sand trap rake 10 further includes first and second elongate smoothing members 42, 44 coupled with the rake head 12 and extending generally outwardly therefrom. The first elongate smoothing member 42 is operatively coupled with the rake head 12 and is positioned forwardly from the first end 34 of the rake head 12. The second elongate smoothing member 44 is operatively coupled with the rake head 12 and disposed rearwardly from the second end 36 of the rake head 12. In the embodiment shown, the first and second smoothing members 42, 44 comprise cylindrical rod-shaped structures having longitudinal extents that are generally aligned with the longitudinal direction 24 of the rake head 12, and the ends of the smoothing members 42, 44 extend beyond the lateral sides of the rake head 12. The first smoothing member 42 is supported by a plurality of first support arms 46 that extend forward from the rake head 12 and are spaced apart along the longitudinal length thereof. Similarly, the second smoothing member 44 is supported by a plurality of second support arms 48 extending rearwardly from the rake head 12 and spaced apart along the longitudinal length thereof.

The first and second smoothing members 42, 44 are positioned and arranged relative to the rake head 12 such that the smoothing members 42, 44 are driven beneath the sand surface following movement of the tines 22 when a user pulls or pushes the rake head 12 through sand to repair a disturbed surface. In the embodiment shown, the first support arms 46 extend outwardly from the rake head 12 such that the first smoothing member 42 is positioned substantially at the level of the proximal ends 30 of the tines 22, as best seen in FIGS. 1, 2, 5, and 6. The second support arms 48 are angled relative to the first support arms 46 such that the second smoothing member 44 is positioned below the level of the first smoothing member 42, and generally between the proximal and distal ends 30, 32 of the tines 22.

While the smoothing members 42, 44 have been shown and described with respect to the illustrated embodiment as comprising cylindrical rod-shaped structures, it will be appreciated that various other elongate structures suitable for being driven beneath the sand surface and smoothing any furrows that may be left as the tines 22 are pulled or pushed through the sand may alternatively be used. Moreover, it will be appreciated that the first smoothing member 42 need not be precisely positioned at the level of the proximal ends 30 of the tines 22, and that the position of the second smoothing member 44 may vary, so long as the first and second smoothing members 42, 44 are positioned to be driven beneath the sand surface as the rake head 12 is pushed or pulled through the sand to repair the surface.

The rake 10 further includes a ferrule 50 coupled with the rake head 12 and which is adapted and configured to receive the handle 14 for grasping by a user during use. In the embodiment shown, a base portion 52 of the ferrule 50 directly engages a plurality of the tines 22a to provide a robust connection of the handle 14 to the rake head 12. In this embodiment, four tines 22 disposed near the longitudinal center of the rake head 12 are directly engaged with the base portion 52 of the ferrule 50. This configuration secures the handle 14 to the rake head 12 while permitting the flow of sand through the respective passages 38 between the tines 22 when the rake 10 is used to repair a sand surface. It will be appreciated, however, that the ferrule 50 may be coupled with the rake head 12 in various other suitable configurations.

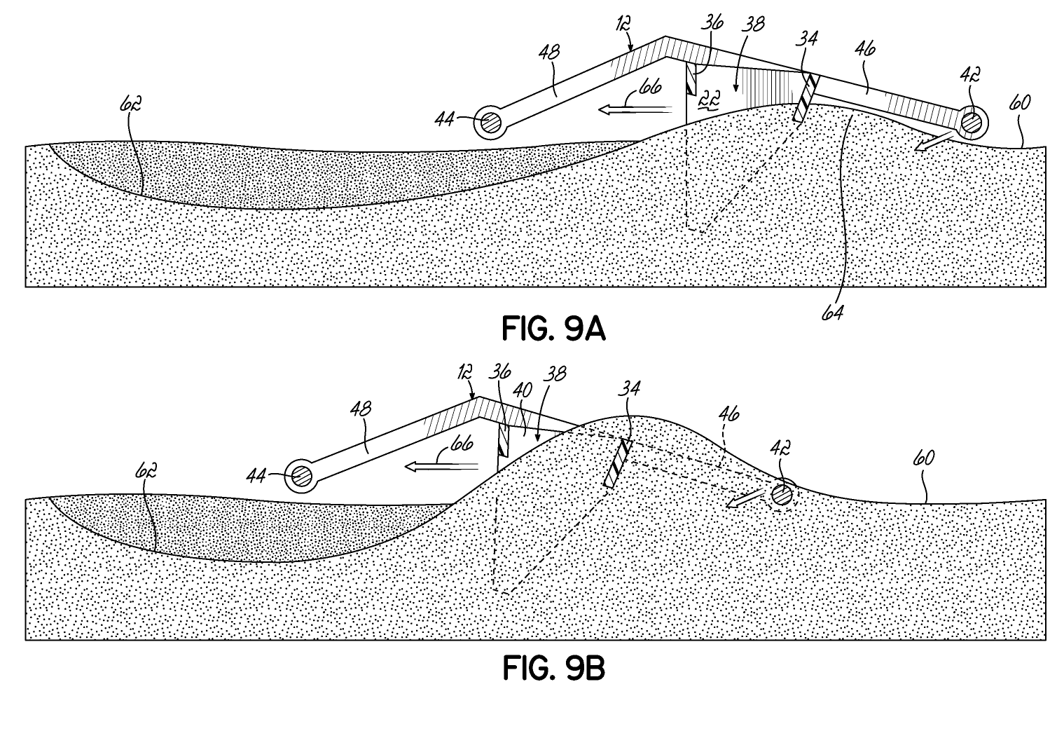

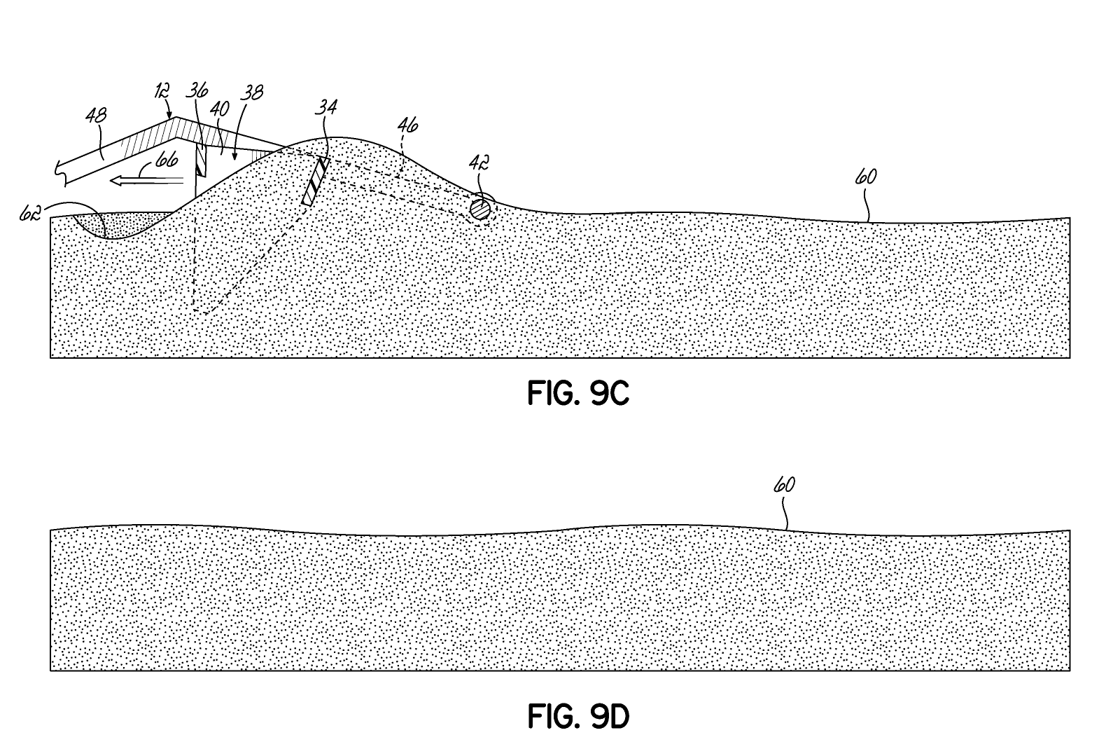

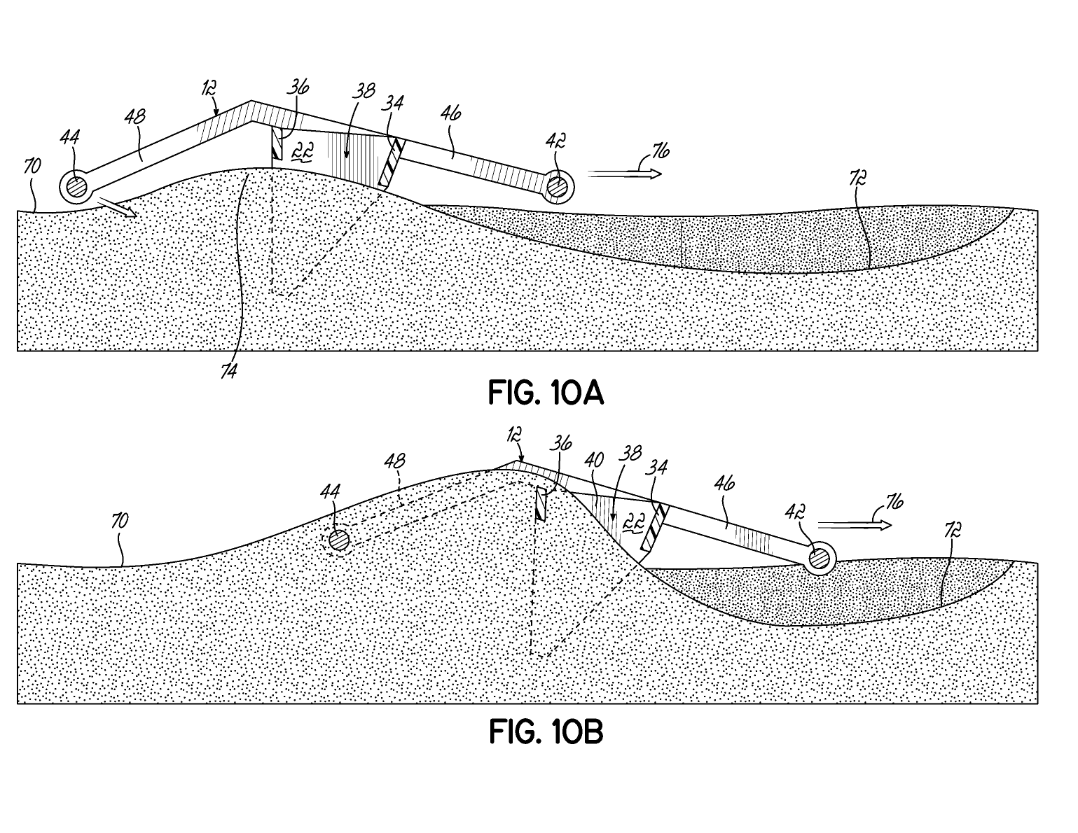

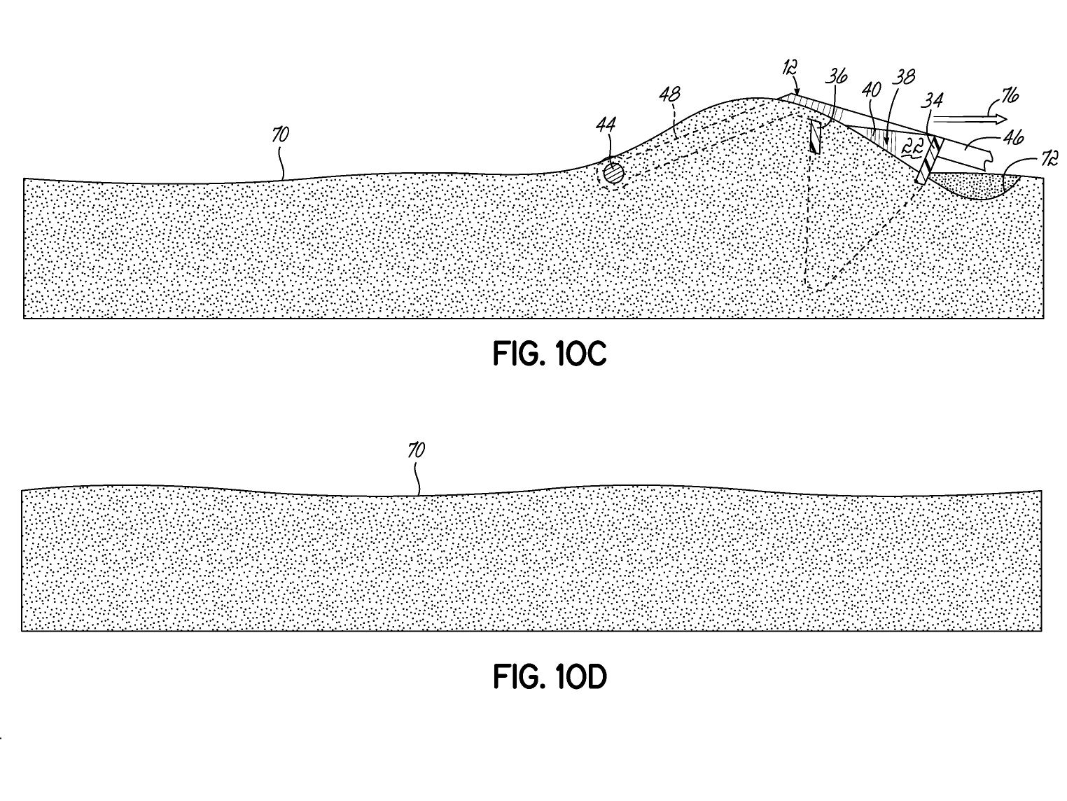

Referring now to FIGS. 9A-9D and 10A-10D, use of the sand trap rake 10 to repair a sand surface will be described. FIGS. 9A-9D illustrate use of the sand trap rake 10 to repair a sand surface 60 wherein the head 12 of the rake 10 is pulled toward the user (not shown). In FIG. 9A, the rake 10 is engaged with the sand surface 60 proximate a depression 62 and a corresponding pile 64 of sand, which may be similar in form to defects in a sand surface 60 that could be caused by a divot created when a user attempts to hit a ball out from the sand trap, or by the depressions of a golfer's footprints across the sand surface 60. In FIG. 9A, the rake 10 is engaged with the sand surface 60 such that the depression 62 and pile 64 lie between the rake head 12 and the user. As the rake 10 is pulled toward the user in the direction of the arrow 66, the tines 22 are moved through the sand to loosen the sand. As the rake 10 is further pulled toward the user, sand may be directed through the passages 38 and excess sand may spill out through openings 40 at the upper side of the rake head 12, as depicted in FIG. 9B. At the same time, the first smoothing member 42 is driven just beneath the surface of the sand, whereby the smoothing member 42 smooths out any furrows created by the tines 22. With continued movement of the rake 10 in a direction toward the user, sand is moved by the tines 22 and the first frame member 34 to fill in the depression, as depicted in FIG. 9C. The first smoothing member 42 follows the rake head 12 and continues to smooth out the sand surface 60 behind the rake 10 such that the repaired sand surface 60 is smooth and free from furrows, ridges, and any piling of the sand at points corresponding to the initiation or end of the pull stroke, as depicted in FIG. 9D.

FIGS. 10A-10D illustrate use of the sand trap rake 10 to repair a sand surface wherein the head 12 of the rake 10 is pushed away from the user. In FIG. 10A, the rake 10 is engaged with the sand surface 70 proximate a depression 72 and a corresponding pile 74 of sand, wherein the rake 10 is positioned between the user and the defect in the sand surface 70. As the rake 10 is pushed away from the user in the direction of the arrow 76, the tines 22 are moved through the sand to loosen the sand, similar to use of the rake 10 described above with respect to FIGS. 9A-9D. As the rake 10 is further pushed away from the user, sand may be directed through the passages 38 and excess sand may exit through openings 40 at the upper side of the rake head 12, as depicted in FIG. 10B. At the same time, the second smoothing member 44 is driven just beneath the surface of the sand, whereby the smoothing member 44 smooths out any furrows created by the tines 22. With continued movement of the rake 10 in a direction away from the user, sand is moved by the tines 22 and the second frame member 36 to fill in the depression 72, as depicted in FIG. 10C. The second smoothing member 44 follows the rake head 12 and continues to smooth out the sand surface 70 behind the rake 10 such that the repaired sand surface 70 is smooth and free from furrows, ridges, and any piling of the sand at points corresponding to the initiation or end of the pull stroke, as depicted in FIG. 10D.

An exemplary sand trap rake 10 in accordance with the principles of the present disclosure may be formed by various suitable methods. In one embodiment, the head 12 of the sand trap rake 10 may be formed from polymeric materials using suitable molding techniques, such as injection molding or transfer molding, for example. Molding the rake head 12 from plastic materials enables the entire rake head 12, tines 22, smoothing members 42, 44, and ferrule 50 to be formed as a unitary structure. In an alternative embodiment, various components of the rake may be formed individually and thereafter assembled together. As a non-limiting example, the rake head 12, tines 22, ferrule 50, and first and second support arms 46, 48 may be formed as a unitary body from plastic material, and the first and second smoothing members 42, 44 may be formed from metallic rod material and thereafter coupled with the first and second support arms 46, 48. Various other methods for manufacturing a sand trap rake 10 in accordance with the principles of the present disclosure will be appreciated by persons skilled in the art.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A sand trap rake for use on golf courses, the rake comprising:
an elongate rake head having a first, front end and a second, back end, the rake head defining a raking direction aligned with a direction extending from the first end to the second end;
a plurality of tines spaced apart along a longitudinal direction of the rake head, transverse to the raking direction;
a first elongate smoothing member operatively coupled with the rake head and disposed forwardly from the first end, the first smoothing member having a longitudinal extent generally aligned with the longitudinal direction of the rake head; and
a second elongate smoothing member operatively coupled with the rake head and disposed rearwardly from the second end, the second smoothing member having a longitudinal extent generally aligned with the longitudinal direction of the rake head.

2. The rake of claim 1, wherein each of the plurality of tines comprises a generally planar tine body, wherein the planes of the respective tines are aligned with the raking direction.

3. The rake of claim 2, wherein the planar bodies of at least some of the tines have a tapered shape that is longer at a proximal end of the tines near the rake head, and is narrower at a distal end spaced from the rake head.

4. The rake of claim 2, wherein a thickness of the planar bodies of at least some of the plurality of tines is approximately 5/32 inch (3.97 mm).

5. The rake of claim 1, wherein:
the plurality of tines define passages extending therebetween; and
the rake head comprises a plurality of openings, each opening aligned with one of the passages.

6. The rake of claim 1, wherein the lengths of the first and second smoothing members extend beyond lateral sides of the rake head.

7. The rake of claim 1, further comprising:
a ferrule coupled with the rake head and adapted to receive a rake handle;
a base portion of the ferrule directly engaging a plurality of the tines.

8. The rake of claim 1, wherein the rake head further comprises:
a first elongate frame member coupled with the tines at the first end of the rake head; and
a second elongate frame member spaced apart from the first frame member and coupled with the tines at the second end of the rake head.

9. A method of repairing a golf sand trap subsequent to play, the method comprising:
engaging the sand surface of the trap with a sand trap rake, the sand trap rake comprising:
an elongate rake head having a first, front end and a second, back end, the rake head defining a raking direction aligned with a direction extending from the first end to the second end,
a plurality of tines spaced apart along a longitudinal direction of the rake head, transverse to the raking direction,
a first elongate smoothing member operatively coupled with the rake head and disposed forwardly from the first end, the first smoothing member having a longitudinal extent generally aligned with the longitudinal direction of the rake head, and
a second elongate smoothing member operatively coupled with the rake head and disposed rearwardly from the second end, the second smoothing member having a longitudinal extent generally aligned with the longitudinal direction of the rake head; and
at least one of pushing or pulling the rake head along the sand surface in the raking direction such that sand is directed through the tines and over at least one of the first or second smoothing members.

10. The method of claim 9, wherein the rake head is pushed along the sand surface and sand is directed through the tines and over the second smoothing member.
